(19) United States
(12) Patent Application Publication
(10) Pub. No.: US 2006/0120357 A1
(43) Pub. Date: Jun. 8, 2006

(54) Programming circuit, light emitting device using the same, and display device

(75) Inventors: Somei Kawasaki, Saitama-shi (JP); Masami Iseki, Yokohama-shi (JP); Fujio Kawano, Kawasaki-shi (JP); Takanori Yamashita, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/290,578

(22) Filed: Dec. 1, 2005

(30) Foreign Application Priority Data
Dec. 3, 2004 (JP) 2004-351360

(51) Int. Cl. H04L 12/66

(52) U.S. Cl. 370/354

(57) ABSTRACT

Even if characteristics of transistors differ every circuit, in order to suppress an influence by the different characteristics and stabilize the programming operation to a control electrode of a drive transistor even if a data signal is small, there is provided a programming apparatus for programming signals which are supplied to a circuit array (61, 62) having a plurality of circuits each having transistors (M11, M12), first switching elements (M21, M22) connected to control electrodes of the transistors, and second switching elements (M31, M32) each connected to one main electrode of each of the transistors. The programming apparatus has: a current generating circuit (M3, M4) which is connected in common to each of the second switching elements of the circuit array and generates a current corresponding to a current flowing in the transistor of the selected circuit; and an operational amplifier (OPAMP1) which is connected in common to each of the first switching elements of the circuit array and supplies the program signal to the control electrode of the transistor of the selected circuit. A data signal and a signal corresponding to the current generated by the current generating circuit are inputted to the operational amplifier.

### BACKGROUND OF THE INVENTION

1. Field of the Invention

The invention relates to a display device of a digital still camera, a digital video camera, a television receiver, a personal computer, or the like, a light emitting device which is used for an exposing apparatus of an electrophotographic printer or the like, and a programming circuit which is used for such a light emitting device.

2. Related Background Art

As a light emitting device, an active matrix type display device will now be described as an example.

FIG. 5 shows a circuit configuration of the active matrix type display device disclosed in Japanese Patent Application Laid-open No. 2004-118181 (U.S. Patent Application Laid-open No. 2004-0066357).

A pixel circuit 1 is constructed by connecting a drive transistor T1, switching elements T2, T3, and T4, a storage capacitor C, and an organic electroluminescence element (OLED) serving as a light emitting element as shown in the diagram.

A gate of the drive transistor T1 is connected to a data line drive circuit 3 through the switching element T2. A drain of the drive transistor T1 is connected to a data line Id through the switching element T3.

The data line drive circuit 3 has a constant current source Ill and a source follower transistor T9.

Vdd denotes a driving power source line connected to a source of the drive transistor T1; SA a selection line to supply a selection signal for exclusively turning on or off either the switching element T3 or T4; and SC another selection line to supply a selection signal for turning on or off the switching element T2.

When the switching elements T2 and T3 are turned on, a programming voltage according to an amount of current supplied to the data line Id is outputted from a source of the transistor T9 and applied to the gate of the drive transistor T1. When the switching element T2 is subsequently turned off, the programming voltage is accumulated into the storage capacitor C. When the switching element T2 is turned on, the current corresponding to the programming voltage accumulated in the storage capacitor is supplied from the drive transistor T1 to the organic EL element (OLED), so that the organic EL element (OLED) emits light. In this instance, in order to enable a setting operating period to be shortened even if the image data current which is supplied to the data line Id is small, the image data current is inputted to the data line drive circuit 3 functioning as a voltage buffer.

FIG. 6 shows a circuit configuration of an active matrix type display device disclosed in Japanese Patent Application Laid-open No. 2003-043993.

The data line drive circuit 3 has an operational amplifier AMP1. A reference voltage Vr is inputted to an inverting input terminal of the operational amplifier and the image data current is inputted to a non-inverting input terminal.

The pixel circuit 1 has a reset switching element T5. When the programming voltage is written, the reset switching element T5 is turned on together with the switching element T2, thereby resetting the organic EL element (OLED).

In the display device, p-channel field effect transistors of the same conductivity type are used for the switching elements T3 and T4. Therefore, their driving is controlled so that the switching elements T3 and T4 are exclusively turned on or off by using two selection lines SA and SB.

FIG. 7 shows a circuit configuration of an active matrix type display device disclosed in Japanese Patent Application Laid-open No. 2003-140613.

A current of the same amount as that of the current flowing in the drive transistor T1 is supplied to a resistor R2 through a switching element T14 by a current mirror circuit comprising transistors T12 and T13 provided in the pixel circuit 1. The current flowing in the drive transistor T1 is detected and inputted as a voltage Vm to the inverting input terminal of the operational amplifier AMP1. The voltage Vr obtained by converting the image data current Id by a resistor R1 is inputted to the non-inverting input terminal of the operational amplifier AMP1. When the voltage Vr and Vm have the same voltage value, the current flowing in the drive transistor T1 and the organic EL element (OLED) is set to a desired value according to the image data current Id. An output voltage of the operational amplifier AMP1 at this time is written as a writing voltage into the gate of the drive transistor T1 through switching elements T7 and T2. Even if the switching element T2 is turned off, the organic EL element (OLED) continues the light emission in accordance with the writing voltage accumulated in the storage capacitor C. Switching elements T6 and T8 and a reset power source Vs are used when an initial voltage of an anode of the organic EL element (OLED) is set.

However, in the circuit of FIG. 7, when the write selecting operation is executed by the image data current, the drive current flows in the organic EL element.

Since the current mirror circuit is provided in each pixel circuit, even if the same drive current is allowed to flow in the drive transistor T1, a value of a monitor current Im which is detected differs every pixel circuit. Consequently, the writing voltage to the gate of the drive transistor T1 differs every pixel circuit.

### SUMMARY OF THE INVENTION

It is an object of the invention to provide a programming apparatus in which even if characteristics of a transistor differs every circuit, an influence by such a difference can be suppressed.

Another object of the invention is to provide a programming apparatus in which even if a data signal is small, the programming operation to a control electrode of a drive transistor can be stabilized.

Still another object of the invention is to provide a light emitting device in which when image data of the same luminance level is inputted, it is difficult to cause a difference between light emission amounts every light emitting element.

According to the invention, there is provided a programming apparatus for programming signals which are supplied to a circuit array having a plurality of circuits each having transistors, first switching elements in each of which one terminal is connected to a control electrode of the transistors, and second switching elements each of which is connected to one main electrode of each of the transistors, comprising:

a current generating circuit which is connected in common to each of the second switching elements of the circuit array and adapted to generate a current corresponding to a current flowing in the transistor of the selected circuit; and

an operational amplifier which is connected in common to each of the first switching elements of the circuit array and adapted to supply the program signal to the control electrode of the transistor of the selected circuit,

wherein the operational amplifier is constructed in such a manner that a data signal is inputted to one input terminal and a signal corresponding to the current generated by the current generating circuit is inputted to the other input terminal.

According to the invention, there is provided a light emitting device comprising:

a plurality of light emitting elements;

a circuit array having a plurality of circuits each having a drive transistor constructed by a thin film transistor (TFT) having an active region of a non-single crystalline semiconductor for driving the corresponding light emitting element, first switching elements in each of which one terminal is connected to a control electrode of the drive transistor, and second switching elements each of which is connected to one main electrode of the drive transistor; and

a programming circuit adapted to program signals which are supplied to the circuit array,

wherein the programming circuit has

a current generating circuit which is connected in common to each of the second switching elements of the circuit array and adapted to generate a current corresponding to a current flowing in the drive transistor of the selected circuit and

an operational amplifier which is connected in common to each of the first switching elements of the circuit array and adapted to supply the program signal to the control electrode of the drive transistor of the selected circuit, and

the operational amplifier is constructed in such a manner that a data signal is inputted to one input terminal and a signal corresponding to the current generated by the current generating circuit is inputted to the other input terminal.

According to the invention, there is provided a display device comprising:

a pixel unit having a plurality of light emitting elements;

a drive circuit unit having a plurality of drive circuits each having a drive transistor constructed by a thin film transistor having an active region of a non-single crystalline semiconductor for driving the corresponding light emitting element, first switching elements in each of which one terminal is connected to a control electrode of the drive transistor, and second switching element connected to one main electrode of the drive transistor; and

a programming circuit adapted to program signals which are supplied to the drive circuit unit,

wherein the programming circuit has

a current generating circuit which is connected in common to each of the second switching elements of the drive circuit unit and adapted to generate a current corresponding to a current flowing in the drive transistor of the selected drive circuit and

an operational amplifier which is connected in common to each of the first switching elements of the drive circuit unit and adapted to supply the program signal to the control electrode of the drive transistor of the selected drive circuit, and

the operational amplifier is constructed in such a manner that a data signal is inputted to one input terminal and a signal corresponding to the current generated by the current generating circuit is inputted to the other input terminal.

According to the invention, the current generating circuit is provided in the programming circuit which is common to each circuit. The programming signal to the control electrode of the drive transistor is determined so that the data signal which is inputted to one input terminal of the operational amplifier is proportional to the signal based on the current which is inputted from the current generating circuit. Even if the characteristics of the drive transistors are different among a plurality of circuits, its influence can be suppressed. Even when the data signal is small, the programming operation to the control electrode of the drive transistor can be stabilized.

### BRIEF DESCRIPTION OF THE DRAWINGS

FIG. 1 is a diagram showing a circuit configuration of a light emitting device using a programming circuit according to an embodiment of the invention;

FIG. 2 is a timing chart for explaining the operation of the light emitting device of FIG. 1;

FIG. 3 is a diagram showing a construction of a display device according to the embodiment of the invention;

FIGS. 4A, 4B, and 4C are diagrams showing a construction of an exposing apparatus for an electrophotographic printer using the light emitting device of the invention;

FIG. 5 is a circuit diagram of a conventional display device;

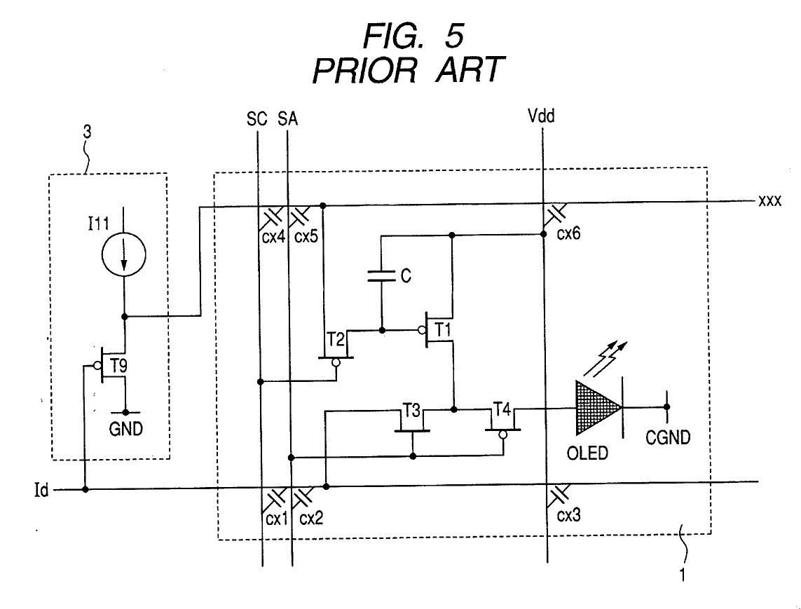

FIG. 6 is a circuit diagram of another conventional display device; and

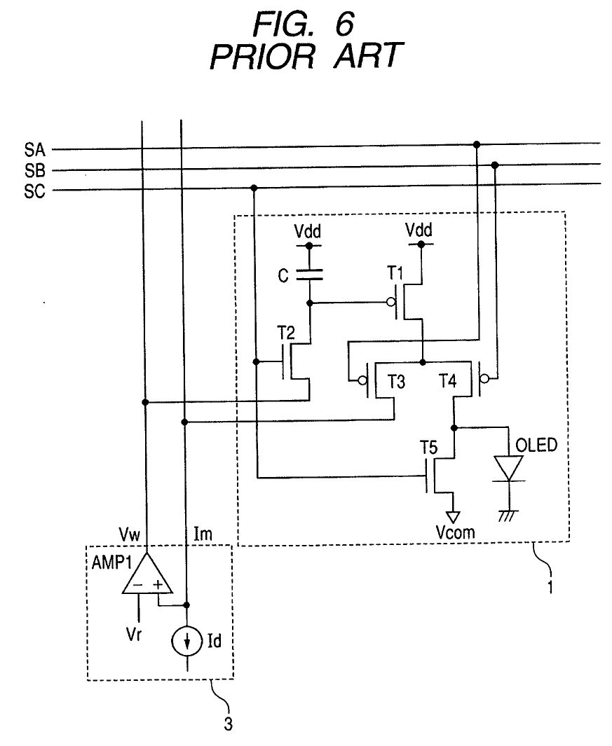

FIG. 7 is a circuit diagram of further another conventional display device.

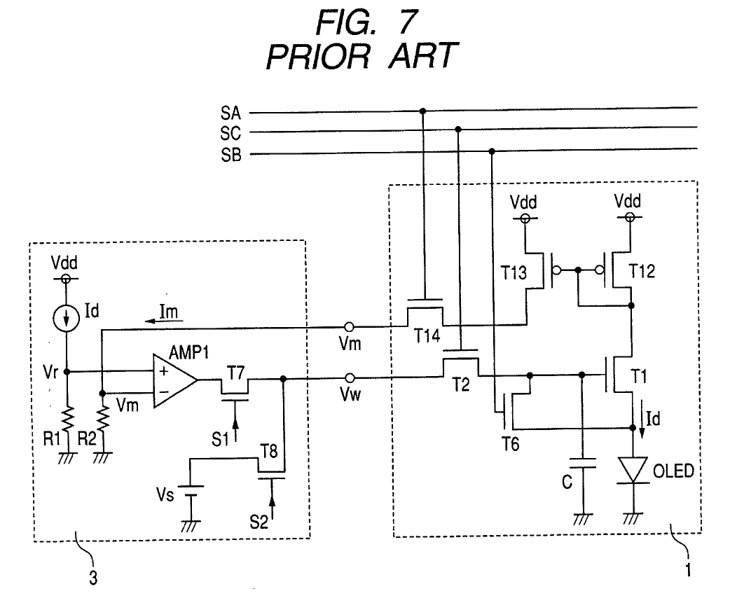

### DETAILED DESCRIPTION OF THE PREFERRED EMBODIMENTS

An embodiment of the invention will be described in detail hereinbelow with reference to the drawings.

### Embodiment 1

The embodiment relates to an active matrix type display device having a programming circuit according to the invention and pixel circuits each constructed by combining drive circuits and light emitting elements, wherein the pixel circuits are two-dimensionally arranged.

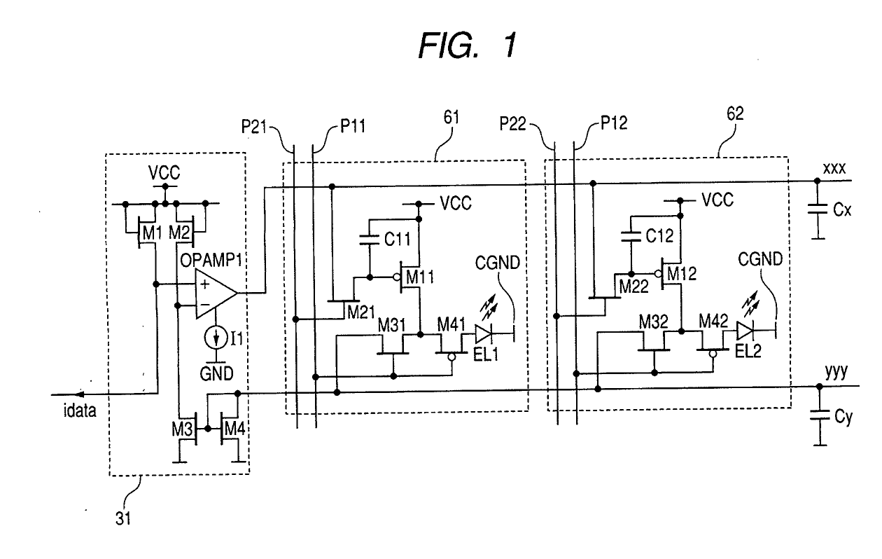

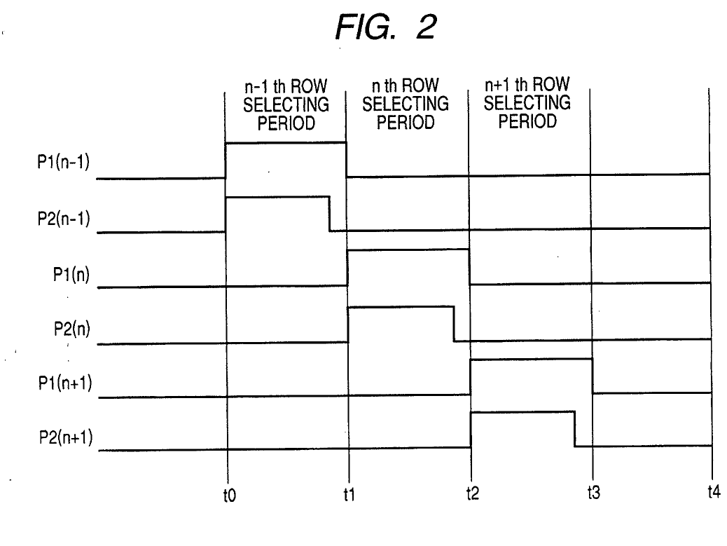

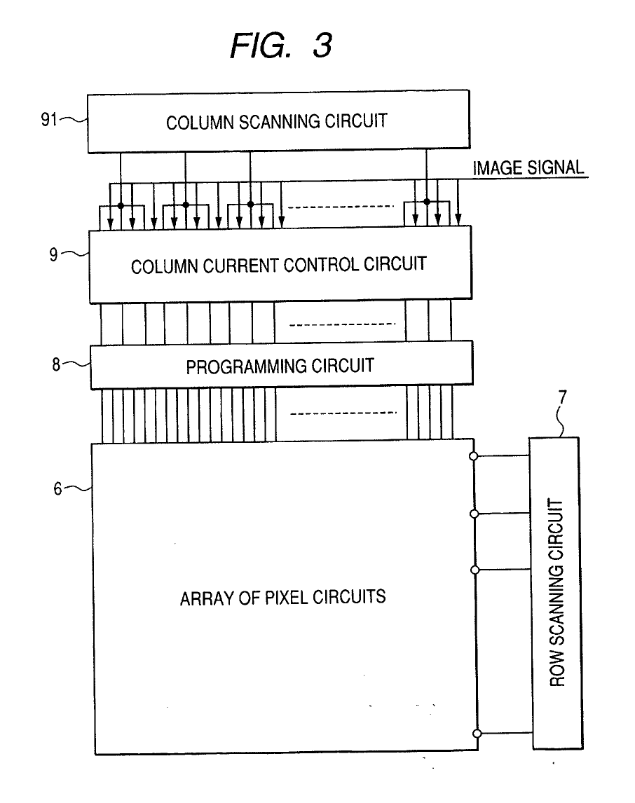

FIG. 1 shows a section of two pixel circuits 61 and 62 and a programming circuit 31. FIG. 2 is a drive timing chart for the pixel circuits corresponding to three rows. FIG. 3 is a block diagram of the display device.

In the embodiment, pMOS transistors M11 and M12 as a kind of field effect transistors (FETs) correspond to the drive transistors. A gate of each pMOS transistor corresponds to the control electrode and a source and a drain of each pMOS transistor correspond to the main electrodes. nMOS transistors M21 and M22 as a kind of field effect transistors correspond to the first switching elements. nMOS transistors M31 and M32 correspond to the second switching elements. A current mirror circuit comprising nMOS transistors M3 and M4 corresponds to the current generating circuit.

The fundamental operation will now be described. A data voltage signal is inputted to one input terminal of an operational amplifier OPAMP1. The data voltage signal is a signal obtained by converting a data current by an nMOS transistor M1. A current from the current generating circuit is converted into a voltage by an nMOS transistor M2 and inputted to the other input terminal of the operational amplifier OPAMP1.

The operational amplifier generates an output signal corresponding to a difference between the input signals. The output signal from the operational amplifier is inputted to the gate of the pMOS transistor M11 or M12 through an auxiliary data line xxx and the nMOS transistor M21 or M22. The current flows between the source and drain of the pMOS transistor M11 or M12 in accordance with a gate voltage. In this manner, the current according to the gate voltage of the pMOS transistor M11 or M12 flows in the nMOS transistor M4 of the current mirror circuit through a feedback data line yyy.

Although the mirror current flows in the nMOS transistor M3, this current is converted into a voltage by the nMOS transistor M2 and inputted to an input terminal of the operational amplifier.

It is assumed here that the nMOS transistors M3 and M4 constructing the current mirror circuit have the same size and its mirror ratio is set to 1:1. It is assumed here that the nMOS transistors M1 and M2 have the same size and their current/voltage conversion ratios are equalized. Thus, the current flowing in the pMOS transistor M11 or M12 is fed back so as to have the same current value as that of an inputted data current idata.

Consequently, even if there is a difference of the source-drain current characteristics to the gate voltage between the pMOS transistors M11 and M12, the same source-drain current as the data current idata is obtained.

Explanation will be made in detail hereinbelow. As shown in FIG. 1, the auxiliary data line xxx and the feedback data line yyy are provided for the first to nth row pixel circuits (n is a positive natural number of 2 or more) (only the first and second row pixel circuits are shown here).

A configuration of the pixel circuit will now be described with respect to the pixel circuit 61 of the first row as an example. The pixel circuit 61 of the first row has a light emitting element EL1 and the PMOS transistor M11 serving as a drive transistor for controlling a current flowing in the light emitting element EL1. The source of the pMOS transistor M11 is connected to a voltage source for supplying a voltage Vcc and a capacitor C11 is arranged between the source and gate. The nMOS transistor M21 whose drain is connected to the gate of the pMOS transistor M11 is provided as a switching element. The nMOS transistor M31 which is arranged between the drain of the pMOS transistor M11 and the feedback data line yyy is provided as a switching element. Further, a pMOS transistor M41 as a switching element is provided between the drain of the pMOS transistor M11 and the light emitting element EL1. The source-drain current of the pMOS transistor M11 flows in the feedback data line yyy.

The nMOS transistor M21 is ON/OFF controlled by a scanning signal P21. The nMOS transistor M31 and the pMOS transistor M41 are ON/OFF controlled by a scanning signal Pl1. A row (pixel circuit) to be selected is determined by the scanning signals P21 and P11.

The programming circuit 31 is constructed by a current-voltage conversion circuit, an operational amplifier, and a current generating circuit. The current-voltage conversion circuit is constructed by the nMOS transistors M1 and M2. A gate and a source of the nMOS transistor M1 are short-circuited. The nMOS transistor M1 is connected to the voltage source for supplying the voltage Vcc and its drain is connected to the data line and a non-inverting input terminal (+) of the operational amplifier. A gate and a source of the nMOS transistor M2 are short-circuited. The nMOS transistor M2 is connected to the voltage source for supplying the voltage Vcc and its drain is connected to a source of the nMOS transistor M3 and an inverting input terminal (−) of the operational amplifier. The current generating circuit is constructed by a current mirror circuit comprising: the nMOS transistor M3; and the nMOS transistor M4 whose gate is connected to the gate of the nMOS transistor M3 and whose source and drain are short-circuited and connected to the feedback data line.

The data current flowing in the data line is converted into the voltage and inputted to the non-inverting input terminal (+) of the operational amplifier. The feedback current flowing in the feedback data line is converted into the voltage and inputted to the inverting input terminal (−) of the operational amplifier. On the basis of a voltage difference between those inputted voltages, the operational amplifier allows a constant current I1 to flow in the auxiliary data line and sets a gate potential of the pMOS transistor M11 so that the source-drain current of the pMOS transistor M11 is equal to the data current.

The operation of the display device of the invention will now be described with reference to FIGS. 2 and 3.

In FIG. 3, reference numeral 6 denotes a pixel circuit unit comprising an array of pixel circuits arranged in a two-dimensional matrix; 7 a row scanning circuit which is connected to the pixel circuits arranged in the row direction (vertical direction) and sequentially outputs row scanning signals P1m and P2m (m is a positive natural number) to the pixel circuits every row; and 8 a programming circuit to which an image data current Idata and the feedback current are inputted and which controls the gate potential of the drive transistor so that the feedback current is equal to the image data current Idata. The programming circuit 8 has a circuit 31 shown in FIG. 1 every pixel circuit column. Reference numeral 9 denotes a column current control circuit for sequentially supplying the image data current Idata to the data lines arranged in the column direction (horizontal direction) and 91 indicates a column scanning circuit which is connected to the column current control circuit 9 and allows the column current control circuit to sequentially sample image signals which are time-sequentially inputted.

In FIGS. 1 and 2, assuming that n 2, the row scanning signal P11 is set to the high level for the first row selecting period of the pixel circuit 61 of the first row. Thus, the nMOS transistor M31 serving as a first programming (row selecting) switch connected to the feedback data line yyy is turned on and the pMOS transistor M41 serving as a light emission selecting switch is turned off. Subsequently, the row scanning signal P21 is set to the high level. Thus, the nMOS transistor M21 serving as a first programming switch connected to the auxiliary data line xxx connected to the operational amplifier is turned on and the output of the operational amplifier is applied to the gate of the pMOS transistor M11. At this time, a data voltage corresponding to the data current is applied to the non-inverting input terminal (+) of the operational amplifier. A voltage corresponding to the current of the feedback data line is applied to the inverting input terminal (−) of the operational amplifier. If the voltage at the inverting input terminal (−) is higher than the data voltage at the non-inverting input terminal (+), the operational amplifier raises the gate potential of the pMOS transistor M11 on the basis of a difference between those voltages. Therefore, the source-drain current decreases. On the contrary, if the voltage at the inverting input terminal (−) is lower than the data voltage at the non-inverting input terminal (+), the operational amplifier drops the gate potential of the pMOS transistor M11 on the basis of the voltage difference. Therefore, the source-drain current increases. In this manner, control is made so that the source-drain current of the PMOS transistor M11 is equalized to the data current. A voltage of the capacitor Cl1 connected to the gate of the pMOS transistor M11 is set to a gate-source voltage enough to allow the current for driving the light emitting element EL1 to flow through the pMOS transistor M11 on the basis of the image data current flowing in the data line. Subsequently, when the row scanning signal P21 is set to the low level, the nMOS transistor M21 is turned off and the voltage of the capacitor C11 is held. A period of time so far is the selecting period (driving current programming period) of the first row.

After that, when the row scanning signal P11 is set to the low level, the nMOS transistor M31 is turned off and the pMOS transistor M41 serving as a light emission selecting switch is turned on. The supply of the driving current to the light emitting element EL1 is controlled by the gate potential of the drive transistor M11 and the current flowing in the light emitting element EL1 is controlled. A period of time during which the current is supplied to the light emitting element EL1 (in the case of a black display, no current is supplied) is a light emitting period (in the case of the black display, non-light emission). When the selecting period of the first row is finished, the selecting period of the second row is started. The drive control signal is sequentially written into the pixel circuit 62 for the selecting period of each row on the basis of the image data signal. That is, according to this pixel circuit, the programming period and the light emitting period are repeated on a row unit basis and still images or motion images can be displayed.

In the embodiment, the gate potential of the drive transistor M11 is controlled by the constant current I1 which is not directly concerned with the data current, so that the operation when the data current is small is improved. The gate potential of the pMOS transistor M11 is controlled through the auxiliary data line. Therefore, although the auxiliary data line xxx has a stray (parasitic) capacitor Cx, even if the data current is small, the current flowing in the auxiliary data line becomes the constant current. Therefore, an influence of the stray capacitor can be reduced more than that in the case of directly supplying the small current to the gate of the drive transistor M11 from the data line. Although the feedback data line yyy also has a stray (parasitic) capacitor Cy, since the diode-connected nMOS transistor M4 of the current generating circuit receives the feedback current, its influence can be lightened.

It is preferable to discretely form capacitors C11 and C12 of the pixel circuit as capacitor elements. A stray capacitor which is formed between the gate and source, for example, an overlap capacitor of a gate electrode and a source region or the like may be used instead of forming them as discrete elements.

According to the programming apparatus of the invention, the data signal is written as a voltage between the source and gate of the drive transistor by the foregoing operation in accordance with the data current value. The source-drain current according to the voltage between the source and gate can be extracted. The current driving type element can be driven by the source-drain current. Specifically speaking, an organic electroluminescence element, an inorganic LED, an organic LED, or a surface conduction electron-emitting device can be mentioned as a current driving type element.

By arranging the pixel circuits in a one- or two-dimensional array, the light emitting device or the display device can be constructed.

Such a light emitting device can construct an active matrix type display device. The light emitting device can construct the image recording apparatus such as an electrophotographic printer or the like in combination with a photosensitive body.

The active matrix type display device can be used for a flat panel television, a viewer which is used in a digital camera, a digital video camera, or the like, a display unit of a cellular phone, or the like. It is also possible that the pixel circuit is constructed by using the electron emitting elements, the pixel circuits are two-dimensionally arranged on a substrate and made to face phosphor in a vacuum chamber, thereby enabling an image display device to be constructed (refer to Japanese Patent Application Laid-open No. H2-257551 and Japanese Patent Application Laid-open No. H4-28137).

It is desirable that each of the drive transistors, the transistors serving as switching elements, and the transistor constructing the operational amplifier according to the embodiment of the invention mentioned above is constructed by a thin film transistor having an active region of a non-single crystalline semiconductor. Amorphous silicon, polysilicon, or the like may be preferably used as a non-single crystalline semiconductor. If an active region (channel) of the thin film transistor is constructed by such a non-single crystalline semiconductor, the device of a larger area can be formed at a lower cost as compared with that in the case of using a single crystalline semiconductor. On the other hand, the thin film transistor made of the non-single crystalline semiconductor is liable to have such a feature that characteristics such as threshold value, gain, and the like are not uniform every transistor. Therefore, the invention is effective in the case where at least the drive transistor is constructed by the thin film transistor. It is not always necessary that the gate insulating film of the transistor is an oxide film may be a nitride such as silicon nitride or the like.

The current mirror circuit constructing the current generating circuit which is used in the invention is not limited to the mirror circuit shown in the diagram but various known mirror circuits can be used. The mirror ratio is not always necessary to be equal to 1:1 but a proper mirror ratio can be selected in accordance with a relation with the inputted data current.

Further, the current-voltage conversion circuit which is used in the invention is not always necessary to be constructed by the diode-connected transistors but may be constructed by a resistor.

### Embodiment 2

According to the embodiment 2, the pixel circuits are arranged in a one-dimensional array and an electrophotographic scanner is constructed as a light emitting device.

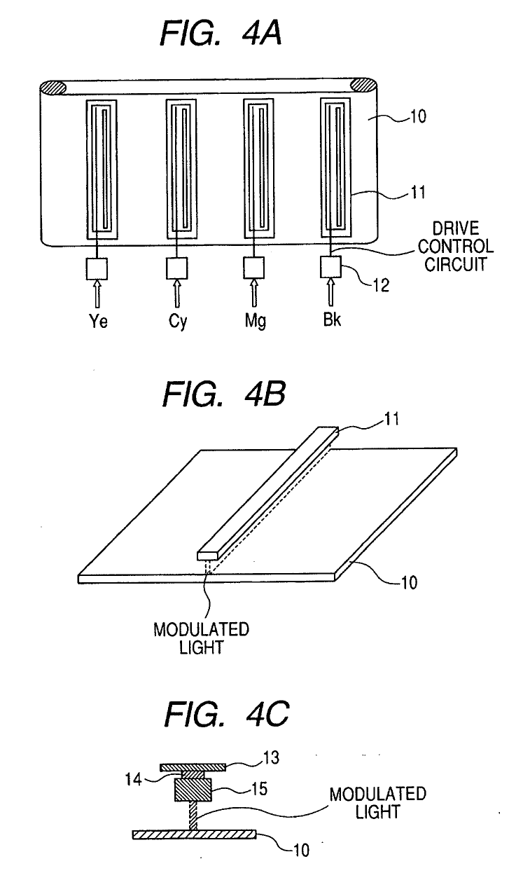

As shown in FIGS. 4A, 4B, and 4C, the image data of the four colors of Ye (yellow), Cy (cyan), Mg (magenta), and Bk (black) is inputted to four OLED (organic EL) scanners 11 through controller ICs 12 and the OLED scanners 11 are allowed to emit light, thereby exposing a photosensitive body 10 such as photosensitive belt or photosensitive drum. Each of the OLED scanners 11 is constructed in such a manner that the array of the pixel circuits as shown in FIG. 1 and the programming circuit 31 provided every column are provided on a TFT circuit substrate 13 and the column current control circuit 9 and column scanning circuit 91 as shown in FIG. 3 are further provided. A light emitting element array 14 is arranged in a line and modulated light sequentially expose the photosensitive body 10 line by line. As necessary, an optical guide member 15 such as a refractive index distribution type lens array or the like is provided between the light emitting element array 14 and the photosensitive body 10.

With the above configuration, the data image of each color is exposed onto the photosensitive body which is moving. The photosensitive body is rotated, toner of each color is deposited onto the surface of the photosensitive body and developed by a developing apparatus (not shown) provided every color, and the toner images formed on the photosensitive body are sequentially transferred onto paper in order of Ye, Cy, Mg, and Bk and fixed by a fixing apparatus. Such a configuration can be used for an electrophotographic printer (optical printer), a copying apparatus or the like combined with an image sensor, and the like.

### Embodiment 3

The embodiment 3 relates to an example in which the programming apparatus is used for an analog memory. For this purpose, in the pixel circuit of FIG. 1, light emitting elements EL1 and EL2 are omitted and a third scan selecting line is provided to control ON/OFF of pMOS transistors M41 and M42 by signals different from the signals P11 and P12, thereby constructing the circuit. By the circuit with such a configuration, the signal corresponding to the data current value is stored as a source-gate voltage of each of the pMOS transistors M11 and M12 and the written current signals are extracted from the PMOS transistors M11 and M12, so that the programming apparatus functions as an analog memory. By one- or two-dimensionally arranging unit circuit portions corresponding to the pixel circuits 61 and 62 with such a circuit configuration as mentioned above, the programming apparatus can be used as an analog line memory or an analog field memory.

This application claims priority from Japanese Patent Application No. 2004-351360 filed Dec. 3, 2004, which is hereby incorporated by reference herein.

What is claimed is:

1. A programming apparatus for programming signals which are supplied to a circuit array having a plurality of circuits,
each circuit having a transistor, first switching element which is connected to a control electrode of said transistor, and second switching element which is connected to one main electrode of said transistor, comprising:
a current generating circuit which is connected in common to each of said second switching elements of said circuit array and adapted to generate a current corresponding to a current flowing in said transistor; and
an operational amplifier which is connected in common to each of said first switching elements of said circuit array and adapted to supply the program signal to the control electrode of said transistor,
wherein said operational amplifier is configurated in such a manner that a data signal is inputted to one input terminal and a signal corresponding to the current generated by said current generating circuit is inputted to the other input terminal.

2. An apparatus according to claim 1, further comprising a current-voltage conversion circuit adapted to convert the current generated by said current generating circuit into a voltage and convert an inputted data current into a voltage signal as said data signal.

3. An apparatus according to claim 2, wherein said current-voltage conversion circuit has a pair of transistors in each of which one main electrode and a control electrode are short-circuited.

4. An apparatus according to claim 1, wherein said current generating circuit has a current mirror circuit.

5. An apparatus according to claim 1, wherein said transistor is a thin film transistor having an active region of a non-single crystalline semiconductor.

6. A light emitting device comprising:
a plurality of light emitting elements; and
said programming apparatus according to claim 1,
wherein said corresponding light emitting element is driven by said transistor.

7. A device according to claim 6, wherein said light emitting element is an organic electroluminescence element.

8. A display device comprising:
a plurality of light emitting elements arranged in a two-dimensional matrix; and
said programming apparatus according to claim 1,
wherein said corresponding light emitting element is driven by said transistor.

9. A device according to claim 8, wherein said light emitting element is an organic electroluminescence element.

10. A light emitting device comprising:
a plurality of light emitting elements;
a circuit array having a plurality of circuits each having a drive transistor constructed by a thin film transistor having an active region of a non-single crystalline semiconductor for driving said corresponding light emitting element, a first switching element is connected to a control electrode of said drive transistor, and a second switching element is connected to one main electrode of said drive transistor; and
a programming circuit adapted to program signals which are supplied to said circuit array,
wherein said programming circuit has
a current generating circuit which is connected in common to each of said second switching elements of said circuit array and adapted to generate a current corresponding to a current flowing in said drive transistor and
an operational amplifier which is connected in common to each of said first switching elements of said circuit array and adapted to supply the program signal to the control electrode of said drive transistor, and
said operational amplifier is configurated in such a manner that a data signal is inputted to one input terminal and a signal corresponding to the current generated by said current generating circuit is inputted to the other input terminal.

11. A display device comprising:
a pixel unit having a plurality of light emitting elements;
a drive circuit unit having a plurality of drive circuits each having a drive transistor constructed by a thin film transistor having an active region of a non-single crystalline semiconductor for driving said corresponding light emitting element, a first switching element is connected to a control electrode of said drive transistor, and a second switching element is connected to one main electrode of said drive transistor; and
a programming circuit adapted to program signals which are supplied to said drive circuit unit,
wherein said programming circuit has
a current generating circuit which is connected in common to each of said second switching elements of said drive circuit unit and adapted to generate a current corresponding to a current flowing in said drive transistor and
an operational amplifier which is connected in common to each of said first switching elements of said drive circuit unit and adapted to supply the program signal to the control electrode of said drive transistor, and
said operational amplifier is configurated in such a manner that a data signal is inputted to one input terminal and a signal corresponding to the current generated by said current generating circuit is inputted to the other input terminal.
